(19) United States
(12) Patent Application Publication
(10) Pub. No.: US 2013/0295900 A1
(43) Pub. Date: Nov. 7, 2013

(54) Detecing a mobile communication device in relationship to a vehicle oerator and implimenting administrative control thereof

(71) Applicant: Bryan Hood, Lago Vista, TX (US)

(72) Inventor: Bryan Hood, Lago Vista, TX (US)

(21) Appl. No.: 13/462,808

(22) Filed: May 2, 2012

(51) Int. Cl. H04W 4/04

(52) U.S. Cl. 455/418

(57) ABSTRACT

Arrangements for controlling operation of a mobile communication device (MCD) are disclosed. The method can determine an identifier associated with the MCD, detect that the MCD is associated with an operational vehicle and that the MCD is associated with an operator of the vehicle. The MCD can query a data base and can determine if the MCD is associated with a MCD feature control profile. One or more MCD features can be deactivated in response to the control profile when it is determined that the operator of an operable vehicle is associated with the MCD having a control profile. Additional embodiments are also disclosed.

### FIELD OF THE DISCLOSURE

The present disclosure is generally related to controlling use of a mobile communication device (MCD) and more particularly to controlling a vehicle operator's use of a MCD.

### BACKGROUND

Usage of a mobile phone, of mobile communication device (MCD) including text messaging (“texting”) while operating a vehicle has proven to be dangerous and costly to society. Recent data shows that while texting, a person has an impairment level twice that of a person who is legally drunk. In the US in 2008, 6,000 deaths were attributed to distraction while driving and many of these fatalities were related to texting. Although many states now have laws prohibiting texting while driving, many drivers continue to violate this law costing millions of dollars in damages. Studies show a person is 23 times more likely to crash when texting behind the wheel. As a result of these alarming statistics, many legislative entities are considering wider bans on cell phone use (text messaging, emailing, browsing, hands on talking etc.,) while driving.

To curtail cell phone use, some have tried jamming systems installed in a vehicle that prevent cell phone use within the vehicle. However, currently it is unlawful to implement an effective jamming system in the U.S. In addition, these jamming systems do not discriminate between the targeted driver's cell phone (for example a bus driver) and other cellular phones in the area, for example a bus rider's cell phone. It can be appreciated that a passenger's phone does not and should not be rendered inoperable and jamming can cause problems for all parties in proximity to the jammer. Such problems can include blocking passengers from making and/or receiving important calls because jamming systems cannot discriminate between phones. There is also a possibility that the cellular jamming system can reach other nearby subscribers and inadvertently disable their ability to use their phone.

Most would agree that there is a need for monitoring and controlling the use of communication devices in a vehicle and that an effective system would save money, benefit society and save lives. However, it is not easy to detect or distinguish the driver's communication device from a passenger's communication device or other nearby devices. Additional issues arise when there is an overriding need for an emergency call when communication devices are disabled by such a system. In such a situation a disabled phone might prevent a disaster or loss of life. Many scholars have written articles about the extreme costs to society, business, municipalities, the government and families related to communication device use while operating a vehicle. An efficient and successful device detection and management system would reduce injuries, save lives, and reduce costs to society generally.

### BRIEF DESCRIPTION OF THE DRAWINGS

FIG. 1 is a block diagram of a system that can be utilized to implement the disclosed system;

FIG. 2 is a spread sheet showing data regarding how an administrator can centrally control the use of a MCD by a driver;

FIG. 3 is a top view of a vehicle where a portion of the disclosed system can be implemented; and

FIG. 4 is a flowchart of a method for administrating communication device by a driver of a moving vehicle.

### DETAILED DESCRIPTION OF THE DRAWINGS

The following is a detailed description of novel embodiments depicted in the accompanying drawings. The embodiments are in such detail as to clearly communicate the subject matter. However, the amount of detail offered is not intended to limit anticipated variations of the described embodiments, but on the contrary, the claims and detailed description are to cover all modifications, equivalents, and alternatives falling within the spirit and scope of the present teachings as defined by the appended claims. The detailed descriptions below are designed to make such embodiments understandable to a person having ordinary skill in the art.

A method for controlling operation of a mobile communication device (MCD) is disclosed. The method can determine an identifier associated with the MCD, detect that the MCD is associated with a moving vehicle and that the MCD is associated with an operator of the vehicle. The MCD can query a remotely located data base stored by a carrier using the MCD identifier and can determine if the MCD has an associated control profile. The system can execute one or more MCD deactivation features in response to the control profile if it is detected that the vehicle associated with the MCD is moving and that the MCD is associated with the operator of the vehicle. Additional embodiments are also disclosed.

Additionally, the system can notify the owner/operator via the MCD of what features typically provided by the MCD have been disabled. In some embodiments an administrator can utilize an online application specific provider (ASP) to enter control profiles for one or more MCD. Administrator input or control profiles can be stored by the carrier at a remotely located database. The administrator can be provided with a graphical user interface that is tailored to the MCD based on configuration setting information received from the MCD. The control profile can be created, displayed and edited using a graphical use interface that has drop down menus with selections that are unique to applications loaded on the MCD.

The control profile entered by the administrator can contain instructions that will disable MCD features or operations such as incoming text messages, outgoing text messages, keypad functionality, display functionality, incoming calls, outgoing calls, incoming transmissions, outgoing transmissions, and/or part of or all of browser functionality. The system can associate the MCD with an operator of a vehicle using a biometric detection system such as a body feature recognition system to include passive biometric detection measure that do not require a user to conduct a specific activity. In other embodiments a subsystem such as the vehicle can require the driver to enter his MCD phone number, a driver's license or some other form of identification.

In some embodiments the MCD profile can be entered into or downloaded to the MCD or to the onboard vehicle processor based system where the MCD control profile is stored locally and the MCD can then be controlled locally either the MCD itself or by the onboard vehicle or auxiliary system. Thus, when it is detected that an operator is in the driver's seat and the MCD is in an operable vehicle, the on board vehicle computer can receive vehicle sensor inputs and can send control signals to the MCD via Bluetooth, Zigbee or Wi-Fi communication link and the onboard local system can disabled features of the MCD. In some embodiments the owner of the vehicle or the maker of the vehicle can install and control the onboard MCD feature control system.

In some embodiments when it is detected that the vehicle is no longer underway or operable, such as the keys are removed or the engine is not running, the system can restore full functionality to the MCD. In some embodiments when prohibited use is detected the camera on the MCD can be activated so the user of the MCD can be positively identified either in real time via a communication link, or after the fact when the video is downloaded for later review.

Thus, the onboard detection and control system can be based and operated entirely locally, where the MCD control profile can be implemented even if the MCD does not have an operable communications link. In addition the local system can track, log and record each time the vehicle operator attempts to or does utilize the MCD. Such data could be useful acting as a black box such as those utilized in the aircraft industry to record vehicle and operator data, which can then be utilized after a crash to reconstruct the events that preceded the accident.

Another aspect disclosed is detecting an operator's input to a vehicle such as an input to a steering wheel or a control petal, and associating operator input to a vehicle response. The vehicle response can include movement of the suspension system of the vehicle, change in revolutions per time of a tire, a vibration, an acceleration of the vehicle in one or more directions, or parameters associated with objects external to the vehicle. The reaction of the vehicle can be compared to movements of persons in the vehicle to identify and distinguish the operator of the vehicle from passengers.

In other embodiments a method of controlling a MCD includes assigning an identifier to the MCD, receiving a communication from the MCD, with the identifier, for communication services and an indicator that the MCD is moving within a vehicle. After receiving the request checking a database using the MCD identifier and determining if the MCD is included in a list of MCD's to be controlled. Next the method can transmit control instructions to the MCD if the MCD is included on the list and the method can monitor usage of the MCD by an operator of a vehicle and report on usage of the MCD by the operator while operating a vehicle.

The MCD can send and the system can receive a vehicle identifier associate the MCD and the vehicle can be associated with the MCD. The control instructions can contain MCD disablement instructions that can control the operation of applications available to the MCD.

In another embodiment an onboard vehicle system is disclosed that can receive a MCD control profile from an administrator or a carrier which has a MCD identifier, where the control profile is tailored to control applications that are executable by the MCD. The on board system can have remote memory to store the disablement parameters associated with the MCD identifier and a receiver, to receive a query for service from the MCD and a processor to access the memory and retrieve the control profile associated with the MCD and a transmitter to transmit the control instruction to the MCD.

The system can detect if an operator of a vehicle is using specific features of specific applications executable by the MCD while the vehicle is under way. Detecting MCD use by the driver can be performed by one of a triangulation system a biometric detection system, a triangulation detection system, or an action-reaction detection system. The vehicle can be identified by a media access control (MAC) address of the onboard vehicle computer.

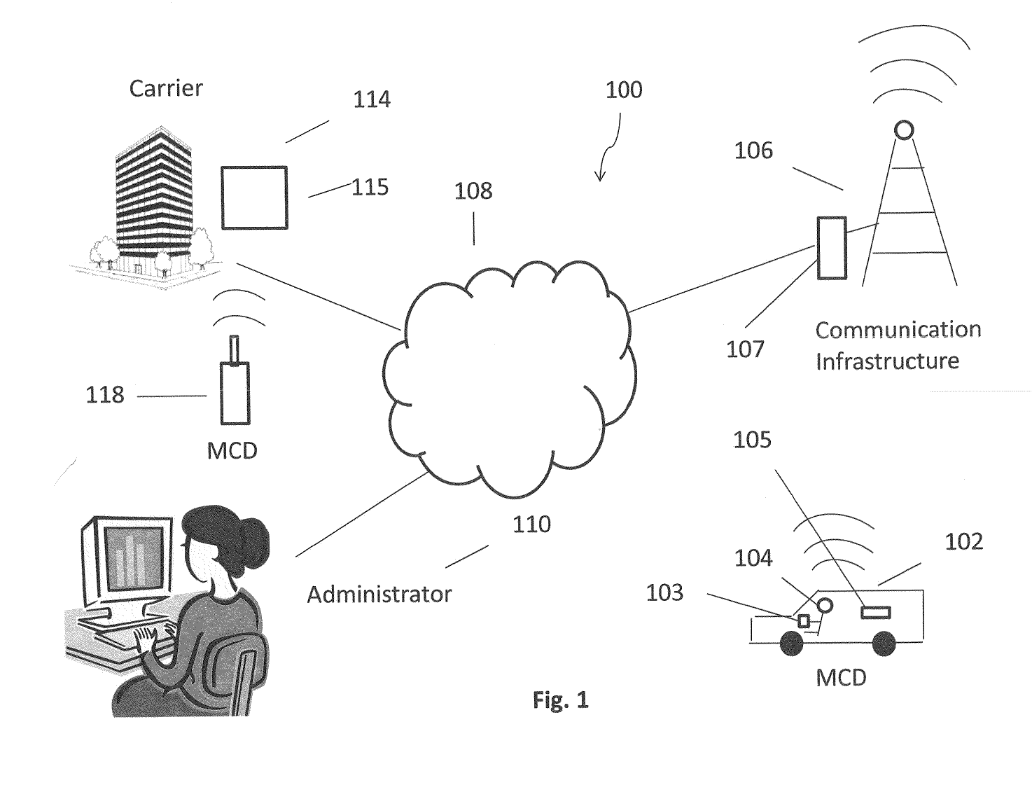

Referring to FIG. 1 a system 100 is depicted that can provide central administrative control of features available to a user of a mobile communication device (MCD). The system 100 is particularly applicable for entities such as municipal transit authorities, common carrier, fleet managers, vehicles rental entities such as U-Haul. Budget, Hertz, Enterprise, Alamo. Ryder, etc., public transportation systems or any entity that has employees who travel as part of their employment. The system 100 can reduce risks and liabilities and thus could be utilized to lower insurance rates for users in compliance with various parameters of the system.

The system can be easily tailored and seamlessly implemented for entities who pay for their employees mobile communication services (MCS), and can significantly reduce liabilities and control risks for either legal or illegal use of a mobile communication device (MCD) by their employees. Thus, the disclosed system allows an entity to effectively and efficiently assert control over their MCD accounts. Such control can provide additional benefits when it is applied to operators with special commercial operator certifications or licenses such as chauffers, bus drivers, over the road truckers, waterborne vehicle pilots, airborne vehicle pilots, and rail based vehicles or train engineers.

For example, a company may have hundreds of traveling salesman that fly to various locations and rent a vehicle, where the company has a policy that their employees are prohibited from using some or all of the features on their MCD while operating a vehicle. For example, in some embodiment, the employer could prevent the operation of incoming and outgoing texts and could disable all games and internet but allow certain applications to be operable such as maps and GPS and allow employees to talk on their MCD while driving only if the MCD is being operated in hands free mode. In such circumstances the disclosed arrangements allow an administrator to remotely monitor and control what features are available to an employee on their MCD while operating a vehicle.

FIG. 1 depicts a system 100 that includes a vehicle 102 with an operator 104, where the operator 104 has access to, and can utilize an MCD 105. The vehicle 102 can also include an onboard system 103 that includes multiple sensors an onboard computer or onboard processor which is Internet connectable. The processor of the onboard system 103 can monitor many sensors within the vehicle 102, can record data acquired from the sensors, can store a control profile, can identify keys and key fobs, can acquire and sore a drivers actions, can control the operable features of the MCD 105 and can communicate with various other devices via the Internet 108.

The processor can sense or detect many different phenomena or parameters such as the existence of MCD 105 in the vehicle 104, the presence of and the weight of, and the force profile of a human in the driver's seat, movement of the drivers body parts, a driver's motions and a driver's inputs to various vehicle systems blue tooth transmissions, hands free MCD operation, facial and fingerprint recognition, proximity of a device to a particular location using RFID technology, etc. The processor can also acquire any data that can be used to detect if the driver has an operable MCD 105 or is in fact is operating MCD 105 while the vehicle 104 is in motion.

The MCD 105 can communicate with other MCDs such as MCD 118 via a communication system. The communication system can include antennae's base stations, repeaters, substations, public ranch exchanges, etc. As shown antenna 106 can connect the MCD 105 to a communication hub or backbone such as that provided by the Internet 108 via base station 107.

A carrier, such as carrier 114 can provide authentication and authorization for MCD's that access and utilize their carrier system 114. For example, each MCD such as MCD 105 can be identified by either or both the MCD manufacturer (a serial number) or the carrier 114 in the form of a subscriber ID possibly via an identifier that is assigned to the MCD 105 via the carrier 114. In some embodiments, the identifier can be programmed into the MCD 105 or the ID can be entered into the MCD 105 via single inline module (SIM).

The system 100 can be compatible with, and can be implemented in any existing mobile communications infrastructure such as a CDMA, TDMA, or GSM system, 3G and 4G systems. TCP/IP, VOW systems as well as future mobile communication infrastructures such as 5G and beyond. In addition, the system 100 can be compatible with all types of MCD's including smart phones such as the i-MCD made by Apple or Android based MCDs such as those made by Motorola. Samsung, LG, Nokia and Sony.

The MCD 105 can be a cellular phone where the owner of the MCD has a subscription to a cellular service provided, or a carrier 114 such as Verizon, AT&T, T-Mobile, Sprint, or Cricket to name a few. Carrier 114 can facilitate accepting, organizing, providing search results regarding entries into a data base that contains data such as MCD identifiers and control features or control profiles for each MCD in the system 100. Thus, under the control of the carrier 114, and remotely located from MCD 105, and via the communication network, the carrier can communicate with and control the features available to the operator of MCD 105. When MCD 105 is moving in vehicle 102, the system can detect such parameters and the system can detect if the operator 104 is able to access or if the operator 104 attempts to or is utilizing various features of the MCD 105. Thus, the features of the MCD 105 available to (or in use by) the operator 104 while the vehicle is underway can be determined and controlled, remotely by the carrier 114. In some embodiments, the system 100 can be set up such that activity of the MCD and the MCD user can be collected and can be e-mailed to interested parties such as the MCD owner, the administrator, the MCD owner's employer, etc.

MCD 105 will typically be in the vicinity of at least one antenna 106, where base station 107 can be co-located with antenna 106. When MCD 105 is powered up, the base station 107 can set up and configure communications between MCD 105 and the carrier's infrastructure. As part of the set-up, the carrier 114 can identify the MCD 105, the area in which the MCD 105 is operating, and movement associated with the MCD 105 and if the administrator 110 has placed any restrictions or a control profile on the MCE 105. The carrier 114 can acquire data about, or parameter related to the vehicle 102, the vehicle operator and the MCD 105 via many communication paths. For example, the carrier 14 can acquire data from a transmitter associated with or controlled by the onboard system 103, where the onboard system 103 can obtain data from one or more sensors (such as vehicle movement sensors) via transmissions made by the MCD 105 or an onboard vehicle transmitter.

The carrier 114 can compare the data it receives from the onboard system 103 and from the MCD 105 and can compare the received data to a control profile entered into database 115 by an administrative system 104 and the system 100 can determine, based on the control profile associated with the MCD, if specific features of the MCD 105 should be disabled. Thus, the administrator can tailor a control profile for each MCD in the system and the carrier 114 can control what features and applications are available to an operator of a vehicle according to the profile. For example, the control profile could be set to disable the display screen or the keypad or just disable the texting feature or could be set to disable various parts of the MCD's operating system.

In some embodiments, during start-up and ongoing operation, a handshake procedure or beacon procedure can be executed between the MCD 105 and the onboard system 103 and the base station 107. Data regarding the vehicle 102, the vehicle operator 104 and the MCD 105 can be transmitted to the carrier 114 via components of the system 100. The administrator setting can be downloaded to the MCD 105 and can be periodically updated. In this configuration, the system 100 and the MCD 105 can limit what features are available even when the MCD 105 does not have a signal or a reliable signal. This control of the MCD 105 can transition from the carrier 114 to the MCD 105, when the MCD 105 does not have enough signal strength to adequately receive control commands from the carrier 114. Thus, for example when the MCD 105 determines that it is moving or in a vehicle, the MCD can disable various features based on the control profile. In some embodiment the control profile and execution thereof can be all performed by the MCD 105.

Based on the data received by the carrier 114, such as an MCD ID, a vehicle ID, an ID of the onboard system 103, vehicle operating parameters, operator identity, vehicle owner information, use of the MCD 105. MCD operating parameters etc., based on the data received, the carrier 114 can access database 115 compare and determine what restrictions administrator 110 has placed on the MCD 105 and can implement the desired MCD feature restrictions.

Thus, when the carrier 114 locates the control profile 114 associated with the MCD or vehicle, the carrier 114 can send control instructions to the MCD 105 and such instructions can control what features are available to the MCD 105 over the carriers system. In some embodiments, the carrier 114 can send control instructions to the MCD 105 thereby restricting one or more of the operations available to the vehicle operator 104. In some embodiments, the carrier 114 based on the control profile can shut down or restrict the operation of various system, applications and/or features available to the vehicle operator 104. For example, the ability of MCD 105 to use or communicate over a short message system (SMS) or multimedia message system (MMS) may be curtailed or thwarted in entirety. The ability of the MCD 105 to provide gaming or access Internet content might be removed. The control instructions received by and implemented by MCD 105 could be tailored to the type of MCD 105 possessed by the operator 104 and to the systems providing subscription services to the MCD 105.

In some embodiments, control of the MCD 105 can be done without outside communications and control (i.e. local control only) and in some embodiments control of the MCD 105 can be switched from exclusively outside or remote based control transmissions to exclusively onboard or local control transmissions. When no or a limited signal is available to the MCD 105, the MCD 105 can receive control system signals that are based, generated and transmitted entirely locally or the control can be totally internal to the MCL 105. In some embodiments the MCD control profile can be implemented even if the MCD does not have an operable communications link and when adequate signal strength is again available the control of the MCD can be switched back to the external system.

In addition, the local system or the external remotely located system can track, log and record each time the vehicle operator attempts to or does utilize the MCD whether the MCD 105 is disabled or not disabled or in communication with the remotely located control system or not. Such data could be useful acting as a black box such as those utilized in the aircraft industry to record vehicle and operator data, which can then be utilized after a crash to reconstruct the events that preceded the accident.

In some embodiments a car key or key FOB having RFID technology or other antitheft technology can be assigned to or associated with a particular individual (heuristically over time) and the vehicles onboard system 103 can recognize the unique signature of the “key” and when the vehicle's onboard system 103 recognizes the key (or the MCD 105 detected that the onboard system 103 recognizes the key) the MCD feature control system can be activated. Such a configuration can positively identify important aspects such as the person using the key, that the key is proximate to the driver's seat (i.e. the vehicle 102 is operable) and that the MCD 105 is in proximity of the vehicle 102 or vehicle operator 104 etc.

In some embodiments, to detect operator usage, the system 100 or 104 can detect user or vehicle operator input to the MCD 105. Such input can be detected by the selection of the MCD's buttons or input to the MCD's microphone, while other sensors can detect changes in vehicle operation in response to operator input (steering, braking accelerating etc.) and movement of the vehicle 102 and prior to providing service to the operator/MCD owner the MCD 105 can shut down operation of or the availability of certain features of the MCD 105.

In other embodiments, the restrictions on the MCD may not be implemented until the operator of the vehicle 102 actually tries to use or operate the MCD 105. In some embodiments triangulation techniques can be utilized to determine that the owner/operator of the MCD 105 is also the operator of the vehicle 102. Triangulation techniques can utilize the inherent time delay from signals (electromagnetic or radio waves, pressure waves, or the like) detectable from three different locations. For example, three or more radio wave sensors can be placed at various locations on the vehicle and based on the time delay from the beacon signal that the MCD 105 periodically transmits, the sensors can determine if the MCD 105 is in reach of the operator of the vehicle. In such a technique, the system 100 can detect if the MCD 105 is in use, accessible, or possessed by the operator 104 of the vehicle 102.

In some embodiments an acoustic relative-ranging system can be utilized to identify who is operating the vehicle 102, where the driver detection system can associate use of the MCD 105 with a particular seat, more specifically the driver's seat. Such a system can be pre-configured such that the MCD 105 communicates with the audio system of the vehicle 102 and the onboard system 103 will determine which seat is the driver's seat. Such a configuration can also use discriminators such as the weight of the person in the driver's seat and compare this to the data in the control profile as a secondary confirmation to positively identify the vehicle operator 104. Thus, data from multiple sensors can be acquired and compares to identify the operator 104 and for distinguishing a driver's use of a MCD 105 as opposed to a passenger's use of a MCD.

Other sensors in or coupled to MCD 105 can acquire and provide data that indicates that the operator of the vehicle is using or can use the MCD 105. For example, the MCD 105 can have a proximity sensor to detect if the MCD 105 is being touched by a hand or fingers, is in close proximity to the ear, head or face, or if the microphone, speaker is active. In some embodiments in addition to detecting an operator's touch, the MCD 105 or car sensors can detect finger or arm movements or finger or arm position. The MCD 105 or the onboard system 103 can report these conditions to the carrier 114. In some embodiments the MCD 105 can detect and report to the carrier 114 if the MCD 105 is operating in hands free mode. For example, the MCD 105 can report to the carrier if head phones are plugged in, if the MCD 105 is in auxiliary speaker mode or if the MCD 105 is in a blue tooth communications mode.

Once the operator of the vehicle 104 has been identified, operator identity information can be sent to the carrier 114 via one or more communication links such as satellite, cell system. Wi-Fi, hot spot, HF Radio, optical etc., possibly by the onboard system 103 via and Internet, cellular, or network type protocol or via other communication channels beyond those used by typical communication carriers. For example the system could utilize communication channels provided by automobile manufacturers such as General Motor's ONSTAR system or BMW's system or other vehicle communication systems (part of 104) that utilize various hardware and forms of communication. In some embodiments, the vehicle 102 can be identified via a department of transportation (DOT) vehicle identification number (VIN) or via a media access control (MAC) address of the onboard system 103.

Based on the VIN, the carrier 114 can determine if the vehicle 102 is part of a company fleet, a rental, fleet, public or private transportation fleet, or the vehicle requires a commercial driver's license or a chauffer's license. Based on the MCD ID the carrier 114 can determine if the MCD 105 is on a corporate plan, a family plan, or is associated with a VIN. In some embodiments the system can be configured to determine if the driver is on the correct route or if the vehicle is stolen and in such circumstances the system can track and locate the vehicle 102. An administrator over the MCD 105 and the vehicle 102, possible as part of a fleet, can continually monitor and update the control features for individual MCD/vehicle combinations.

In some embodiments the system can be configured to disable the MCD'S ability to operate games. In some embodiments the system 100 and/or the onboard system 104 can detect if a MCD operator/owner is trying to, has attempted to, or has tamper with any part of the disclosed MCD system. Thus, the carrier 114 or the MCD 105 can record attempted alterations and record such attempts to tamper with any the disablement feature. In some embodiments a parent could be the administrator monitoring tampering type activities conducted by their child. Such activities could activate a reporting system of the MCD 105 such that the administrator or an employer is notified of such tampering activity. In other embodiments an employer or the government entity such as a court could be the administrator for detecting tampering by employees and/or by violators or persons on probation. The system could be set up based on a court order for one who has a past history of violating laws or has had a serious accident due to use of an MCD while driving.

In some embodiments, operation of the MCD 105 by a driver can be prohibited by the carrier 114 where the carrier 114 can send control signals to the MCD 105 and/or can disable features provided by the base station of the carrier's portion of the system. Thus, the processor in the MCD 105 can execute control instructions that have been received from the carrier 114, where executing such instructions can disable some of all of the MCD's features. In some embodiment, code can be loaded on the MCD 105 such that when the MCD 105 has no service or is beyond the communication of an antenna or base station, the MCD 105 can enter a disablement mode where the operator of the MCD 105 cannot play games or operate the MCD 105 even though the MCD 105 is out of communication range from the carrier 114.

Thus, if the MCD 105 detects that it is being operated by the driver, and there is no measurable carrier signal, the system can ensure that the MCD 105 is disabled as a default since in this situation the carrier 114 cannot communicate with the MCD 105. In some embodiments the MCD 105 can be controlled by the carrier 114 and in the event that the carrier 114 loses communication with the MCD 105, the MCD 105 can implement the disablement features. Accordingly the system can have the carrier disable the MCD 105 and when the carrier 114 loses contact with the MCD 105, the MCD 105 can independently within the vehicle, etc. disable the MCD 105.

The disclosed system is equally effective regardless of the type of vehicle or vessel in which the MCD 105 is traveling and the classification of the vehicle, i.e. common carrier, personal automobile etc. For example, the system is equally applicable to land vehicles such as cars, trucks, trains and motorcycles and water vehicles, such as ships, yachts, boats, personal water craft etc., and airborne vehicles such as commercial airliners, general aviation aircraft, to home built aircraft and most particularly to all “common carriers” that transport people and goods like trains, busses, large trucks, aircraft, sea going vessels, etc.

In some embodiments the system 100 or onboard system 104 can be configured such that some or all features of all of the MCDs in a vehicle are disabled. Such a configuration could be applied when an administrator 110 such as a parent does not want passengers in their vehicle (such as passenger friends of their son or daughter) to be using an MCD in the vehicle 102 while their vehicle 102 is being operated. Such a feature could prevent the operator of the vehicle 104 from being distracted by a passenger or other occupant of the vehicle.

In some embodiments system 100 or onboard system 104 can use the MCD's operating system to detect various MCD operations during vehicle operation and the MCD 105 can communicate such a status to the onboard system 103 via a blue tooth protocol. In addition, the onboard system 103 can send data to the MCD 105 via a blue tooth protocol signals to the MCD 105 to control operation of features of the MCD 105. For example a blue tooth format could be used communicate with the MCD 105 and to shut the MCD 105 off or disable specific features on the MCD 105.

In some embodiments, insurance companies can enter into an agreement with their insured (MCD owner operators) and the insured can agree to allow the insurance company to have access to certain or specific data regarding the MCD owners use of the MCD 105 where the insurance company can get high level data regarding whether and the occurrence(s) texting while driving actually occurred but not data that would be so detailed as to invade the privacy of the MCD user/owner. In some embodiments the system could allow a court to place an order to implement the features of the system 100 for offenders where the system can monitor and prevent high risk offenders from using their MCD because the MCD owner has been ticketed for illegal use of their MCD or they have caused accident/death and such a catastrophe was caused because of MCD user indiscretion.

In some embodiments, depending on the way the administrator has configured the control features the system 100 can be set to automatically configure MCD features such that incoming and outgoing calls or texts for any MCD in the vehicle (or just the vehicle operator's MCD 105) are automatically routed to the vehicle's communications system, i.e. audio system. Thus, a voice recognitions system can convert a driver's voice to text and can convert a test to an audible sound, where such a conversion can be performed with minimal distraction to the driver. In some embodiments if the vehicle does not have such a capability such as blue tooth connectivity, then incoming calls and tests can be routed to the user's voice mail. Such features can be offered as standard apps or they could be embedded in the operating system of the MCD.

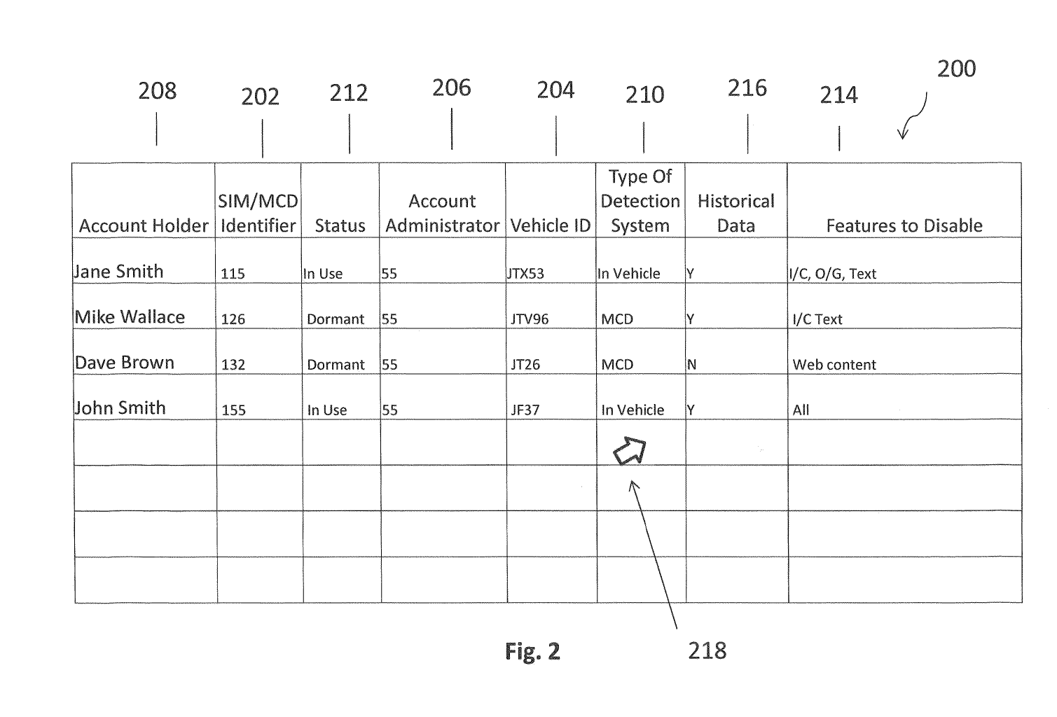

Referring to FIG. 2, a spread sheet 200 such as one that could be provided to the administrator 110 in FIG. 1 is illustrated. The administrator can edit the control profile for one or many MCD's via pointing device 218 and keyboard (not shown) via the graphical user interface shown. The spread sheet can have a column that indicates a MCD identifier 202, a vehicle identifier 204, account administrator 206 account holder 208, the type of detection system 210, status 212, what features are to be disabled 214, and a historical data column 216. Some of the columns such as the disable features column 214 and the historical data column 216 can provide links to full pages if information. For example, selecting the historical data column 216 can show how much use and what type of use a MCD user has performed while operating a vehicle, when such use occurred etc.

The configured account control profile for each MCD, can control the availability of various features of individual MCDs to include incoming and outgoing texts, calls, games, and usage generally. The control profile can be used to set individual permissions for use of use of an MCD, particularly when the system 100 detects that the MCD can or is being used by a vehicle operator. The MCD's shown in the spreadsheet can be MCD's that are all on a single corporate account or they can be a collection of subscriber accounts where the owners/users of the MCD can agree to be part of a group of MCD's that can be controlled or monitored by a specific administrator each having a unique administrator identifier. The account administrator can set the level of access allowed by the system (of MCD).

In some embodiments, the system can operate on an application by application basis or an application type by application type. For example, the system can be set to control all applications that are classified as a browser and can be set up to restrict some or all of the features provided by such a browser.

Thus, the spread sheet can be configured to block certain or all features available on the MCD via a browser application, such as internet access (requests for information, and/or data reception) or various web based applications and access to certain websites or types of websites. In some embodiments, the operation of MCD applications that control incoming and/or outgoing texts can be controlled by the carrier's part of the system and in some embodiments, by the MCD itself. For example the account administrator can partially block, partially allow or block or allow every feature based on how the administrator configures setting for each MCD individually and the system can implement the most efficient ways to implement control of such features.

Thus, possible control signals can include, block texts commands where the administrator can choose between several options such as block all inbound and outbound text messages, block only inbound or block only outbound texts or block or allow only texts from specific numbers/domains, etc. Another administrator configuration can include partial or total blocking of digital media downloads which the MCD can block a device user from purchasing applications, music, games, ringers, screen savers, etc. through the subscribers network.

In another configuration the administrator can restrict Web access, where such a restriction can allow a MCD user to access only approved sites such as family-friendly sites or non-streaming sites. Another setting can include configurations to block data transfer. Such setting can allow an administrator to set limits on the user of the MCD ability to use any features that require data, such as email, location services, Web based services, video sites etc. In yet another embodiment the administrator can set-up the system so that the user is blocked from usage of voice features, where the administrator can block all out-going or outbound calls, block out-going calls to specific numbers or area codes or can block just incoming or inbound calls from all, or specific locations or numbers or any combination thereof. Yet additional setting can include blocking all inbound/incoming and outbound/outgoing pictures and video, and/or electronic mail.

In some embodiments the administrator can grant and edit permissions for a specific MCD to allow a user to set data, voice, picture mail and text controls for their own device. The carrier can also allow the administrator via the simple webpage shown to have the power to set MCD use limits by time of day or week. The administrator can also implement MCD account settings that monitor MCD usage while driving and can monitor downloads to the MCD and to manage various on-demand controls and receive optional alerts that can allow the administrator to keep track of a MCD.

In some embodiments the carrier can provide an easy to understand report or a dashboard that shows individual MCD usage. Thus the administrator can get reports regarding the controls and limits set and these reports can be organized by time of day, day of week month of year etc. Thus if a company, entity, business owner, parent, (i.e. administrator) wants to prohibit MCD use (except for emergency calls) while the owner of the MCD is driving or during driving hours, the administrator can quickly set up such a system.

In some embodiments the administrator can see what is being texted or that the user is talking or who and when the MCD operator is texting. The administrator can further establish an allowed list of phone numbers that can connect with the MCD. The system also allows for the administrator to see what apps the MCD owner is downloading to the MCD. Thus the administrator can set alerts and stay informed of any potentially concerning behavior. Accordingly, the data acquisition system can be operated by the carrier and this system can track the time a spent talking and texting while driving and such data can be viewed by the administrator. The system can receive driver, vehicle and MCD information and compare this data with subscription features, and administrator settings and send and/or implement to selectively disable all or part of the features normally available on the MCD.

In some embodiments the system allows for selective enablement or disablement of specified features as far as what is activate and what is deactivate and how it is enabled or disables (selective disablement). For example the entire MCD, certain features (provided by controller) Incoming, outgoing voice, text, e-mail, browser.

Deactivation can be controlled in many ways. For example, the system can fully shut down the MCD similar to what would happen if the MCD was turn off or did not have a SIM card installed. So the carrier could change parameters such that the carriers system did not recognize the SIM identifier. This configuration would still allow for emergency calls to be made by the vehicle operator.

In some embodiments the system can send an audible message to the MCD that has features deactivates where the message can contain words such as, “It has been detected that this MCD is associated with a driver of a vehicle. Thus, due to safety concerns, one or more features typically available on this MCD have temporarily been disabled due to safety concerns.

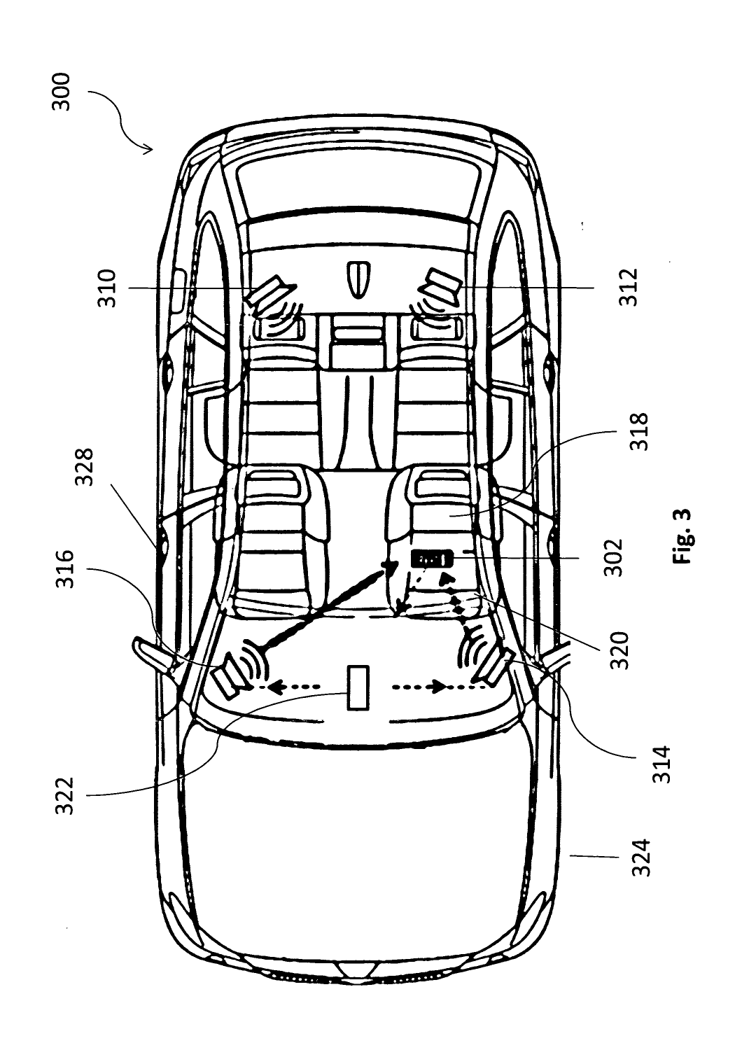

Referring to FIG. 3 a vehicle system 300 is shown that has various sensors and systems that can be utilized to detect of a MCD 302 is available for and and/or in use while the owner of the MCD is operating the vehicle 300. The vehicle system 300 can include a processor with communication capability, door sensors 328, four speakers 310, 312, 314, and 316, seat sensors 318, steering wheel sensors 320, motion sensors 322, vehicle sensors 324 and other vehicle parameter sensors and vehicle system sensors.

In some embodiments the disclosed arrangements can use sensors 302-328 in combination with processor 330 and/or the processor within MCD 302 to determine whether the driver has possession of is trying to or is using the MCD 302. In some embodiments the sensor can be mounted on the steering wheel or driver's seat and can detect the presence of the driver via heat, capacitance, touch, conductivity, pressure or other biometric parameter provided by the driver's contact with seat and/or steering wheel during vehicle operation. A transmitter can be coupled to a transmitter and a receiver such that the data collected at the steering wheel can be sent via a wired or wireless link to controller, which can then relay the measurement results to a carrier via the vehicle's information control system.

In some embodiments a combination of sensors can positively identify the individual who is sitting in the driver's seat during vehicle operation. One way to identify the driver is detecting who is touching or moving the steering wheel during vehicle operation. Such detection can be accomplished using multiple sensors which can access stored data and compare stored data to near real time data real (stored either locally or remotely) and can compare the retrieved data with the data obtained by the sensors to look for matching characteristics. In some embodiments one or more sensors can be placed on the steering wheel or control input of the vehicle and the sensors can determine who is driving or alternately if the driver is operating a MCD 302.

In some embodiments a vehicle operators seat can be utilized that via sensors can provide driver identity, while the driver is sitting down. Such a seat may contain many sensors that can provide data regarding the drivers weight, amount of lowest, highest and average pressure applied to various areas of the seat. Such data for a particular individual typically will not differ in a relatively short time span. Using this data in combination with other near real time or stored/historical data can identify the driver with sufficient accuracy. The algorithm that makes the identification can use multiple data sources and can implement heuristic learning or can execute a more rigid algorithm or software routine. Such a system can provide extremely accurate identification regarding who is driving a particular vehicle.

In some embodiments the system can employ a voice recognition system to detect if the operator of the vehicle is talking on the MCD. For example, if no other voices are heard in the vehicle other than that of the driver, and the MCD is transmitting over the network simultaneously or nearly simultaneously with detection the voice of the driver, the system can infer that the driver is talking on the MCD 105.

In some embodiments, strictly passive, strictly active or a combination of passive and active driver detection system can be utilized to identify the driver. Various forms of passive biometric detection sensors and methods can be utilized to identify the driver. In other embodiments less automated or active detection methods which require direct driver input could be utilized, such as requiring the driver to enter a personal identification number or to swipe an ID card, a driver's license or a credit card that requires can be utilized to identify the driver. In some embodiments a combination of user input and passive biometric detection can be utilized to identify the driver. Biometric detection mechanism can include fingerprint detection systems, eye detection systems, facial recognition systems, weight profile, handprint body conductivity, body capacitance or some other body feature recognition system.

Thus, the detection system can be implemented similar to how vehicle interlock breathalyzer operate where a user has to provide some input to the vehicle system in order to start or operate the vehicle. For example the driver will be requested to actively provide some form of identification, ancillary, biometric or an ID number which can provide accurate identification of the driver.

In some embodiments, sensors can detect the motion of one of the driver's appendages such as the motion of the driver's leg or arm can be detected by a sensor and the disclosed arrangements can relate the movement of the users arm or leg to a phenomena exhibited by the vehicle or vehicle system. For example, movement of an arm can be associated with a switch such as a window switch, or any control button, or movement of the steering wheel or a petal and the corresponding vehicle response such as acceleration, deceleration, or a turn.

More specifically, the change of parameters in control input of the vehicle such as the brake petal can be compare to known action response signatures that associate a driver's movement with a change in vehicle system settings or parameters. In some embodiments, the disclosed arrangements can detect movement of say the driver's leg, and correspondingly movement of a vehicle system control input such as movement of the vehicles' brake petal or gas petal. Thus, via stored sensor data a driver profiles can be created over time starting with the disclosed meta-data based recognition process using a determination of a person's biometric or physical parameters such as height, weight, hair color, fingerprint, eye color. etc. Such data can be compared to a sample trace to determine driver identity.

In some embodiments the sample trace of a driver and a passenger can be embodied as a micro-movement signature and many scenarios for driver detection can be generated. A simple scenario would be active input requiring a driver to generate an input that can be related to driver identification prior to or during operation of the vehicle. Active inputs can include filing out a form, a card swipe, a biometric input or personal identification number to name a few. In some embodiments a passive identification system can be utilized. Examples of passive detection systems can be very sophisticated to include detection of the location of the MCD in the vehicle, on the driver/operator, proximate to the operator and movement of the driver in relationship to movement of the MCD can be analyzed to determine if the MCD belongs to the driver.

For example, a micro-movement signature/verification can he created/verified when a driver movement such as movement of the driver's right leg (towards the center of the vehicle) presses down on the gas or brake pedal and when the MCD is suspected to be in a pocket or within arm's reach, possibly plugging the MCD into a charger or pacing the MCD into a cradle. Sensors can determine how many people are in the car in addition to the operator.

A driver recognition cycle can consist of three distinct periods. One a sudden change in the axis of a vehicle such as pitch or roll of the vehicle when the user moves and appendage and in response a parameter of the vehicle changes such as movement of a pedal or switch, the volume of the radio or movement of a petal or switch such as a turn signal, acceleration, deceleration a change in direction etc. Second, there is a period of no activity for a period when the vehicle parameter is sensed (for example the pedal or switch is kept pressed). In addition, typically there will be another change of parameters such as pitch or roll when a switch or pedal is finally released.

In some embodiments, the MCD can be associated with the driver by detecting and detecting various MCD movements in relationship to vehicle movement in relationship to diver movement or activity. Such movement can be detected and measured using sensors such as accelerometers, a position sensor, or a global positioning sensor, a gyro a piezeo electric sensor or other sensor to detect parameters such as movement, acceleration, change in orientation, speed, r direction and magnitude. The outputs to these sensors can define motions that are monitored by a commonly available processor running on commercially available software such as Motion Tracker, from Trimble and with On-the-Fly processed data files from Trimble Total Control that are run in a Mat-lab program in order to get values for the detected motions and create plots showing the created true motion and the by GPS measured motion. The acquisition, processing, storage and dissemination of vocal, pictorial, textual and numerical information by a microelectronics-based combination of computing and telecommunications.

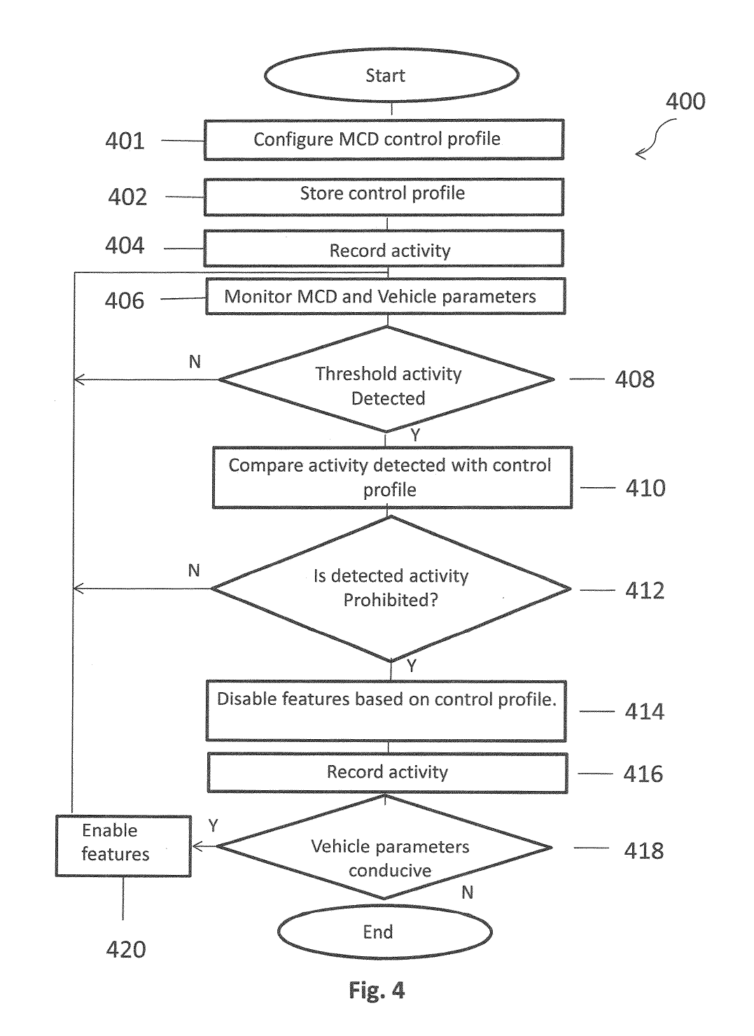

Referring to FIG. 4 a flow diagram is provided that depicts a process 400 that can be implemented according to the disclosed arrangements. The process starts and proceeds to block 401 where a mobile communication device (MCD) feature management table or control profile can be configured or can be entered into a database from a remote location. As illustrated by block 402, the control profile can be entered and uploaded to the carrier and stored. In some embodiments the control profile can be entered into an onboard vehicle system or into the MCD itself. As illustrated by block 404, the MCD, the onboard system or the carrier can monitor MCD or MCD user activity and can store such activity. As illustrated by 406, the MCD, onboard system and/or carrier can monitor vehicle parameters in relationship to use of the MCD. Sensors in the vehicle determine if the key is proximate to the MCD, is proximate to the onboard system, if the vehicle is moving, can identify the vehicle, and can detect and log vehicle operator use of the MCD.

As illustrated by decision block 408, the system can detect threshold usage or activity of an MCD that is associated with an operator of an operable vehicle. If no detection is made, the system can continue to monitor MCD parameters and vehicle parameters as illustrated by blocks 404 and 406 and if detection is made, the system can compare the usage of the MCD with the allowed features in the MCD's control profile as illustrated by block 410.

As illustrated by decision block 412, if a usage of certain MCD features are detected and are to be managed according to the MCD's control profile, then one or more MCD features can be disabled according to the control profile as illustrated by block 414. If, as illustrated by decision block 412 the system does not detect MCD and vehicle related activity that runs afoul of the control features in the MCD control profile or there is no prohibited features in use, or in attempted use, the system can continue to monitor as illustrated by blocks 404 and 406. All events and activity can be monitored and recorded in a database as illustrated in block 416.

As illustrated by decision block 418 if the system determines that the vehicle is no longer operable, for example the key has been removed from the keyhole then as illustrated by block 420 the system can enable the previous disabled features and the system can return to a monitoring state as is illustrate in blocks 404 and 406. The process can end thereafter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method for controlling operation of a mobile communication device (MCD) comprising:
determining an identifier associated with the MCD;
detecting that the MCD is associated with an operational vehicle;
detecting that the MCD is associated with an operator of the operational vehicle;
querying a remotely located data base using the MCD identifier;
determining if the MCD has an associated control profile; and
executing MCD deactivation features in response to the control profile if it is detected that the vehicle associated with the MCD is moving and that the MCD is associated with the operator of the vehicle.

2. The method of claim 1 further comprising notifying the operator via the MCD that at least some features of the MCD have been disabled.

3. The method of claim 1 further comprising facilitating administrator control of the control profile via a connection to a remote database.

4. The method of a claim 3 further comprising creating the control profile using a graphical use interface by selecting a pre-selectable disablement features.

5. The method of claim 3 further comprising creating the control profile by entering control features for each application that can be executed by the MCD.

6. The method of claim 5 further comprising determining applications that are available to the MCD and providing drop down menus with administrator selectable control features based on the applications that are available to the MCD.

7. The method of claim 1 wherein the control profile contains instructions to disable one of, incoming text messages, outgoing text messages, keypad functionality, display functionality, incoming calls, outgoing calls, incoming transmissions, outgoing transmissions, and part of or all of browser functionality.

8. The method of claim 1 wherein associating the MCD with a driver comprises using a biometric detection system such as a body feature recognition system.

9. The method of claim 8 wherein the at least one biometric detection measure includes passive biometric detection measure that does not require the operator to enter data.

10. The method of claim 1 further comprising downloading a control profile to the MCD and if the MCD has an inoperable communication link disabling features available on the MCD based on a locally stored control profile.

11. The method of claim 1, further comprising detecting an operator input to the vehicle such as an input to a steering wheel or a control petal, and associating such an input to a vehicle response including one of movement of the suspension system of the vehicle, change in revolutions per time of a tire, a vibration, an acceleration of the vehicle in one or more directions, or parameters associated with objects external to the vehicle and using such an association to identify an operator of the vehicle.

12. A method of controlling a mobile communications device (MCD) comprising:
assigning an identifier to the MCD;
receiving a communication from the MCD with the identifier, the communication requesting communication services and including an indicator that the MCD is associated with an operable vehicle;
checking a control profile associated with the MCD identifier;
retrieving control instructions to be executed by the MCD if the MCD is associated with the control profile;
monitoring usage of the MCD by an operator of a vehicle; and
reporting on usage of the MCD by the operator of the vehicle.

13. The method of claim 12 further comprising associating the vehicle with the MCD.

14. The method of claim 12 wherein receiving further comprises receiving a vehicle identifier

15. The method of claim 12 wherein the control instructions contain MCD disablement instructions operable on applications available to the MCD.

16. A system comprising:
a mobile communication device (MCD) control profile input system to receive administrator input, the administrative input having a MCD identifier and being tailored to control applications that are executable by the MCD;
memory to store the disablement parameters associated with the MCD identifier;
a receiver to receive a query, the query requesting communication services, the query having a MCD identifier;
a processor to access the memory and retrieve the control profile associated with the MCD identifier: and
a transmitter to transmit the control instruction to the MCD.

17. The system of claim 16 further comprising detecting if an operator of a vehicle is using specific features of specific applications executable by the MCD.

18. The system of claim 16 wherein the detecting the driver is performed by one of a triangulation system a biometric detection system, a triangulation detection system, or an action-reaction detection system.

19. The system of claim 16 wherein identifying the vehicle comprises using a MAC address of an onboard computer processor.

20. The system of claim 16, further comprising associating the vehicle with the MCD.
